(19) United States
(12) Patent Application Publication
(10) Pub. No.: US 2021/0393997 A1
(43) Pub. Date: Dec. 23, 2021

(54) RESPIRATOR MASK WITH EXHALATION FILTER

(71) Applicant: MSA Technology, LLC, Cranberry Township, PA (US)

(72) Inventors: Aaron Tyler Jewitt, Valencia, PA (US); Kayleigh Nichelle Westbrook, Toronto, OH (US); Adam Bilger, Cranberry Township, PA (US)

(21) Appl. No.: 17/347,625

(22) Filed: Jun. 15, 2021

Related U.S. Application Data
(60) Provisional application No. 63/041,539, filed on Jun. 19, 2020.

(51) Int. Cl. A62B 23/02; A62B 18/08; A62B 18/02

(52) U.S. Cl. CPC A62B 23/02; A62B 18/08; A62B 18/025; A62B 18/084

(57) ABSTRACT

A respirator mask includes a face piece configured for contacting at least a portion of a face of a user, a head harness for attaching the respirator mask to a head of the user, at least one opening on the face piece, and at least one filter associated with the opening on the face piece. The at least one filter is configured to facilitate a passage of ambient air to an interior of the face piece in a first direction. The at least one filter is further configured to facilitate a passage of air exhaled by the user wearing the respirator mask in a second direction opposite the first direction from the interior of the face piece to the ambient air and reduce a passage of aerosolized particulate matter exhaled by the user in the second direction.

### CROSS-REFERENCE TO RELATED APPLICATION

This application claims priority to U.S. Provisional Patent Application No. 63/041,539, filed Jun. 19, 2020, the disclosure of which is incorporated by reference herein in its entirety.

### TECHNICAL BACKGROUND

### Technical Field

The present disclosure is generally directed to respirator masks, such as full-face masks and half-face masks. In particular, the present disclosure is directed to respirator masks having an exhalation filter.

### Technical Considerations

As is known in the art, air-purifying respirators are worn on a user's face to protect the individual from noxious gases, vapors, fumes, and particulates. In particular, such masks filter the air breathed by a user to remove the noxious gases, vapors, fumes, and particulates while enabling oxygen in the atmosphere to reach the user. An air-purifying respirator typically includes three parts: a face piece, a filter unit, and a head harness for attaching the respirator to the user's head. The face piece can be or include a full-face respirator mask, covering the entire face and forming a seal therewith; or it can be a half-face respirator mask, covering only the nose and mouth and forming a seal therewith. The head harness typically consists of a yoke with straps attached thereto. The yoke is attached to the face piece, such that when the straps are worn, the head harness keeps the face piece sealed against the face.

The filter unit is connected to the face piece, such as at an air inhalation portion, and removes the noxious substances and/or particulate matter from the air as air is inhaled into the face piece. The filter unit may be a detachable filter unit, such as a filter cartridge. Some respirators may have a pair of detachable filter cartridges connected on opposing sides of the face piece to the air inhalation portions (e.g., air inlet valves). The face piece also includes an air exhalation portion, which permits exhaled air to be vented directly to the outside of the face piece, but which remains closed during inhalation so that all inhaled air passes through the filter unit.

Exhaling air through the air exhalation portion allows aerosolized particulate matter from the user's breath to be introduced directly into the surrounding environment. Additionally, moisture from the user's breath may accumulate on the air exhalation portion during prolonged wearing of the respirator mask. This moisture may drip to the outside environment.

Exhalation of aerosolized particulate matter from the user's breath into the environment may pose a health risk to individuals in close proximity to the user. For example, if the user wearing the respirator mask is infected with an infectious disease that may be transmitted through close contact with other individuals, such as severe acute respiratory syndrome coronavirus 2 (SARS-CoV-2), simple activities such as coughing, sneezing, talking, or breathing through the respirator mask may expel aerosolized particulate matter through the air exhalation portion, which may then present risk of infection to other individuals in close proximity Accordingly, it would be desirable to reduce or eliminate the exhalation of aerosolized particulate matter through the air exhalation portion of the respiratory mask.

### SUMMARY OF THE DISCLOSURE

Generally, provided is an improved respirator mask having an exhalation filter configured to prevent or reduce the exhalation of aerosolized particulate matter from the user's breath. According to some non-limiting embodiments or aspects, provided is a respirator mask that may include a face piece configured for contacting at least a portion of a face of a user, a head harness configured for attaching the respirator mask to a head of the user, at least one opening on the face piece, and at least one filter associated with the opening on the face piece. The at least one filter may be configured to facilitate a passage of ambient air to an interior of the face piece in a first direction. The at least one filter may be configured to facilitate a passage of air exhaled by the user wearing the respirator mask in a second direction opposite the first direction from the interior of the face piece to the ambient air and reduce a passage of aerosolized particulate matter exhaled by the user in the second direction.

According to some non-limiting embodiments or aspects, the at least one filter may be a valveless, two-way filter. The at least one filter may include a first connector, the opening on the face piece may include a second connector, and the first connector and the second connector may be configured to permit removable attachment of the at least one filter to the face piece. The at least one filter may meet bacterial and viral filtering efficiency for medical or non-medical use.

According to some non-limiting embodiments or aspects, a speech diaphragm may be connected to a speech opening on the face piece positioned in front of a mouth of the user. The speech diaphragm may be an acoustic membrane and an elastomeric gasket may surround a perimeter of the acoustic membrane. The face piece may include a recess surrounding the speech opening, and the gasket may be received within the recess. The gasket may have a first sealing surface configured for making a first point of contact with the recess and a second sealing surface configured for making a second point of contact with the recess.

According to some non-limiting embodiments or aspects, the at least one filter may include a first filter and a second filter, wherein the first filter is configured for preferential flow in the first direction and secondary flow in the second direction, and wherein the second filter is configured for preferential flow in the second direction and secondary flow in the first direction.

According to some non-limiting embodiments or aspects, a respirator mask may include a face piece configured for contacting at least a portion of a face of a user; a head harness configured for attaching the respirator mask to a head of the user; an air inlet on the face piece, the air inlet having at least one first filter configured to facilitate a passage of ambient air to an interior of the face piece in a first direction; and an air outlet on the face piece, the air outlet having at least one second filter configured to facilitate a passage of air exhaled by the user wearing the respirator mask in a second direction opposite the first direction from the interior of the face piece to the ambient air and reduce a passage of aerosolized particulate matter exhaled by the user in the second direction.

According to some non-limiting embodiments or aspects, one of the air inlet and the at least one first filter may include a one-way air inhalation valve that is configured to be in an open position during inhalation and in a closed position during exhalation. One of the air outlet and the at least one second filter may include a one-way air exhalation valve that is configured to be in an open position during exhalation and in a closed position during inhalation.

According to some non-limiting embodiments or aspects, the at least one first filter may include a first connector, the air inlet on the face piece may include a second connector, and the first connector and the second connector may be configured to permit removable attachment of the at least one first filter to the face piece. The at least one second filter may include a first connector, the air outlet on the face piece may include a second connector, and the first connector and the second connector may be configured to permit removable attachment of the at least one second filter to the face piece. The at least one first filter and the at least one second filter may meet bacterial and viral filtering efficiency for medical or non-medical use.

According to some non-limiting embodiments or aspects, a speech diaphragm may be connected to a speech opening on the face piece positioned in front of a mouth of the user. The speech diaphragm may be an acoustic membrane and an elastomeric gasket may surround a perimeter of the acoustic membrane. The face piece may include a recess surrounding the speech opening, and the gasket may be received within the recess. The gasket may have a first sealing surface configured for making a first point of contact with the recess and a second sealing surface configured for making a second point of contact with the recess.

According to some non-limiting embodiments or aspects, the head harness may include one or more adjustable straps.

In accordance with some non-limiting embodiments or aspects, the respirator mask may be characterized by one or more of the following clauses:

Clause 1: A respirator mask, comprising: a face piece configured for contacting at least a portion of a face of a user; a head harness configured for attaching the respirator mask to a head of the user; at least one opening on the face piece; and at least one filter associated with the opening on the face piece, wherein the at least one filter is configured to facilitate a passage of ambient air to an interior of the face piece in a first direction, and wherein the at least one filter is configured to facilitate a passage of air exhaled by the user wearing the respirator mask in a second direction opposite the first direction from the interior of the face piece to the ambient air and reduce a passage of aerosolized particulate matter exhaled by the user in the second direction.

Clause 2: The respirator mask of clause 1, wherein the at least one filter is a valveless, two-way filter.

Clause 3: The respirator mask of clause 1 or 2, wherein the at least one filter comprises a first connector, wherein the opening on the face piece comprises a second connector, and wherein the first connector and the second connector are configured to permit removable attachment of the at least one filter to the face piece.

Clause 4: The respirator mask of any of clauses 1-3, wherein the at least one filter meets bacterial and viral filtering efficiency for medical or non-medical use.

Clause 5: The respirator mask of any of clauses 1-4, further comprising a speech diaphragm connected to a speech opening on the face piece positioned in front of a mouth of the user.

Clause 6: The respirator mask of any of clauses 1-5, wherein the speech diaphragm is an acoustic membrane and wherein an elastomeric gasket surrounds a perimeter of the acoustic membrane.

Clause 7: The respirator mask of any of clauses 1-6, wherein the face piece comprises a recess surrounding the speech opening, and wherein the gasket is received within the recess.

Clause 8: The respirator mask of any of clauses 1-7, wherein the gasket has a first sealing surface configured for making a first point of contact with the recess and a second sealing surface configured for making a second point of contact with the recess.

Clause 9: The respirator mask of any of clauses 1-8, wherein the at least one filter comprises a first filter and a second filter, wherein the first filter is configured for preferential flow in the first direction and secondary flow in the second direction, and wherein the second filter is configured for preferential flow in the second direction and secondary flow in the second direction.

Clause 10: A respirator mask, comprising: a face piece configured for contacting at least a portion of a face of a user; a head harness configured for attaching the respirator mask to a head of the user; an air inlet on the face piece, the air inlet having at least one first filter configured to facilitate a passage of ambient air to an interior of the face piece in a first direction; an air outlet on the face piece, the air outlet having at least one second filter configured to facilitate a passage of air exhaled by the user wearing the respirator mask in a second direction opposite the first direction from the interior of the face piece to the ambient air and reduce a passage of aerosolized particulate matter exhaled by the user in the second direction.

Clause 11: The respirator mask of clause 10, wherein one of the air inlet and the at least one first filter comprises a one-way air inhalation valve that is configured to be in an open position during inhalation and in a closed position during exhalation.

Clause 12: The respirator mask of clause 10 or 11, wherein one of the air outlet and the at least one second filter comprises a one-way air exhalation valve that is configured to be in an open position during exhalation and in a closed position during inhalation.

Clause 13: The respirator mask of any of clauses 10-12, wherein the at least one first filter comprises a first connector, wherein the air inlet on the face piece comprises a second connector, and wherein the first connector and the second connector are configured to permit removable attachment of the at least one first filter to the face piece.

Clause 14: The respirator mask of any of clauses 10-13, wherein the at least one second filter comprises a first connector, wherein the air outlet on the face piece comprises a second connector, and wherein the first connector and the second connector are configured to permit removable attachment of the at least one second filter to the face piece.

Clause 15: The respirator mask of any of clauses 10-14, wherein the at least one first filter and the at least one second filter meet bacterial and viral filtering efficiency for medical or non-medical use.

Clause 16: The respirator mask of any of clauses 10-15, further comprising a speech diaphragm connected to a speech opening on the face piece positioned in front of a mouth of the user.

Clause 17: The respirator mask of any of clauses 10-16, wherein the speech diaphragm is an acoustic membrane and wherein an elastomeric gasket surrounds a perimeter of the acoustic membrane.

Clause 18: The respirator mask of any of clauses 10-17, wherein the face piece comprises a recess surrounding the speech opening, and wherein the gasket is received within the recess.

Clause 19: The respirator mask of any of clauses 10-18, wherein the gasket has a first sealing surface configured for making a first point of contact with the recess and a second sealing surface configured for making a second point of contact with the recess.

Clause 20: The respirator mask of any of clauses 10-19, wherein the at least one filter comprises a first filter and a second filter, wherein the first filter is configured for preferential flow in the first direction and secondary flow in the second direction, and wherein the second filter is configured for preferential flow in the second direction and secondary flow in the first direction.

These and other features and characteristics of respirator masks described herein, as well as the methods of manufacture of such masks, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only.

### BRIEF DESCRIPTION OF THE DRAWINGS

FIG. 1 is a front view of a full-face respirator mask according to some non-limiting embodiments or aspects of the present disclosure;

FIG. 2 is a side view of the respirator mask of FIG. 1;

FIG. 3 is a front view of a half-face respirator mask according to some non-limiting embodiments or aspects of the present disclosure;

FIG. 4 is a side view of the respirator mask of FIG. 3;

FIG. 5A is a front view of a half-face respirator mask having an exhalation filter according to some non-limiting embodiments or aspects of the present disclosure;

FIG. 5B is a front view of a half-face respirator mask having an exhalation filter according to some non-limiting embodiments or aspects of the present disclosure;

FIG. 5C is a front view of a half-face respirator mask having an exhalation filter and a speech diaphragm according to some non-limiting embodiments or aspects of the present disclosure;

FIG. 6 is a front view of a half-face respirator mask having an exhalation filter according to some non-limiting embodiments or aspects of the present disclosure;

FIG. 7 is an inner view of a face piece of the half-face respirator mask shown in FIG. 6;

FIG. 8 is a front view of a half-face respirator mask having an exhalation filter according to some non-limiting embodiments or aspects of the present disclosure;

FIG. 9 is a front view of a half-face respirator mask having an exhalation filter and a speech diaphragm according to some non-limiting embodiments or aspects of the present disclosure;

FIG. 10 is a partial cross-sectional view of a face piece of the half-face respirator mask of FIG. 9 shown connected to a user's face;

FIG. 11A is an exploded view of the half-face respirator mask shown in FIG. 9;

FIG. 11B is a detailed cross-sectional view of the speech diaphragm and the face piece of the half-face respirator mask shown in FIG. 9;

FIG. 12 is a front view of a half-face respirator mask having an exhalation filter and speech diaphragm according to some non-limiting embodiments or aspects of the present disclosure; and

FIG. 13 is a front view of a half-face respirator mask having an exhalation filter according to some non-limiting embodiments or aspects of the present disclosure.

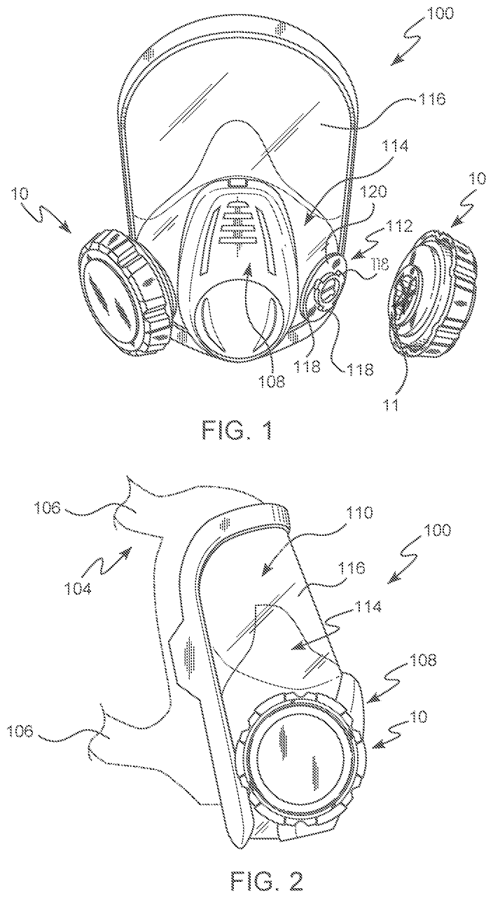

In FIGS. 1-13 the same characters represent the same components unless otherwise indicated.

### DETAILED DESCRIPTION

As used herein, the singular form of “a”, “an”, and “the” include plural referents unless the context clearly dictates otherwise.

Spatial or directional terms, such as “left”, “right”, “inner”, “outer”, “above”, “below”, and the like, relate to the invention as shown in the drawing figures and are not to be considered as limiting as the invention can assume various alternative orientations.

All numbers used in the specification and claims are to be understood as being modified in all instances by the term “about”. By “about” is meant within plus or minus twenty-five percent of the stated value. However, this should not be considered as limiting to any analysis of the values under the doctrine of equivalents.

Unless otherwise indicated, all ranges or ratios disclosed herein are to be understood to encompass the beginning and ending values and any and all subranges or subratios subsumed therein. For example, a stated range or ratio of “1 to 10” should be considered to include any and all subranges or subratios between (and inclusive of) the minimum value of 1 and the maximum value of 10; that is, all subranges or subratios beginning with a minimum value of 1 or more and ending with a maximum value of 10 or less. The ranges and/or ratios disclosed herein represent the average values over the specified range and/or ratio.

The terms “first”, “second”, and the like are not intended to refer to any particular order or chronology, but refer to different conditions, properties, or elements.

All documents referred to herein are “incorporated by reference” in their entirety.

The term “at least” is synonymous with “greater than or equal to”.

As used herein, “at least one of” is synonymous with “one or more of”. For example, the phrase “at least one of A, B, or C” means any one of A, B, or C, or any combination of any two or more of A, B, or C. For example, “at least one of A, B, and C” includes A alone; or B alone; or C alone; or A and B; or A and C; or B and C; or all of A, B, and C.

The term “includes” is synonymous with “comprises”.

As used herein, the terms “parallel” or “substantially parallel” mean a relative angle as between two objects (if extended to theoretical intersection), such as elongated objects and including reference lines, that is from 0° to 5°, or from 0° to 3°, or from 0° to 2°, or from 0° to 1°, or from 0° to 0.5°, or from 0° to 0.25°, or from 0° to 0.1°, inclusive of the recited values.

As used herein, the terms “perpendicular” or “substantially perpendicular” mean a relative angle as between two objects at their real or theoretical intersection is from 85° to 90°, or from 87° to 90°, or from 88° to 90°, or from 89° to 90°, or from 89.5° to 90°, or from 89.75° to 90°, or from 89.9° to 90°, inclusive of the recited values.

The discussion of various examples or aspects may describe certain features as being “particularly” or “preferably” within certain limitations (e.g., “preferably”, “more preferably”, or “even more preferably”, within certain limitations). It is to be understood that the disclosure is not limited to these particular or preferred limitations but encompasses the entire scope of the various examples and aspects described herein.

The disclosure comprises, consists of, or consists essentially of, the following examples or aspects, in any combination. Various examples or aspects of the disclosure are illustrated in separate drawing figures. However, it is to be understood that this is simply for ease of illustration and discussion. In the practice of the disclosure, one or more examples or aspects shown in one drawing figure can be combined with one or more examples or aspects shown in one or more of the other drawing figures.

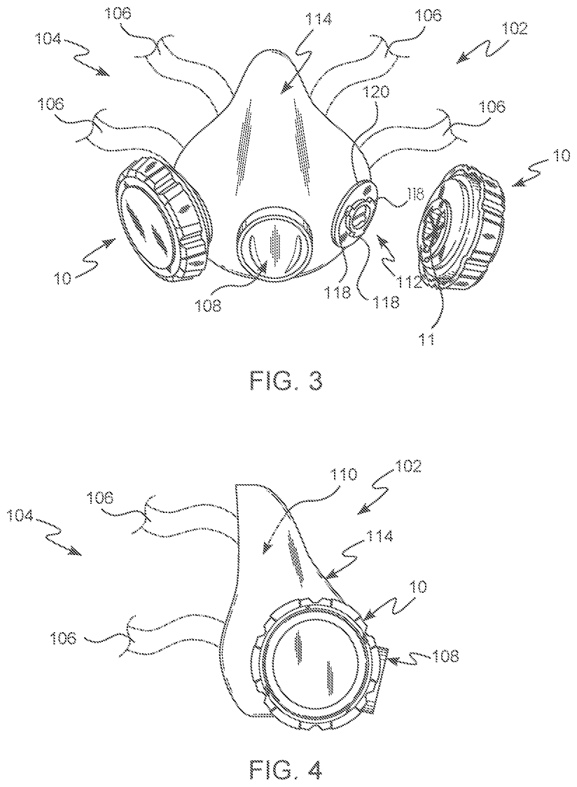

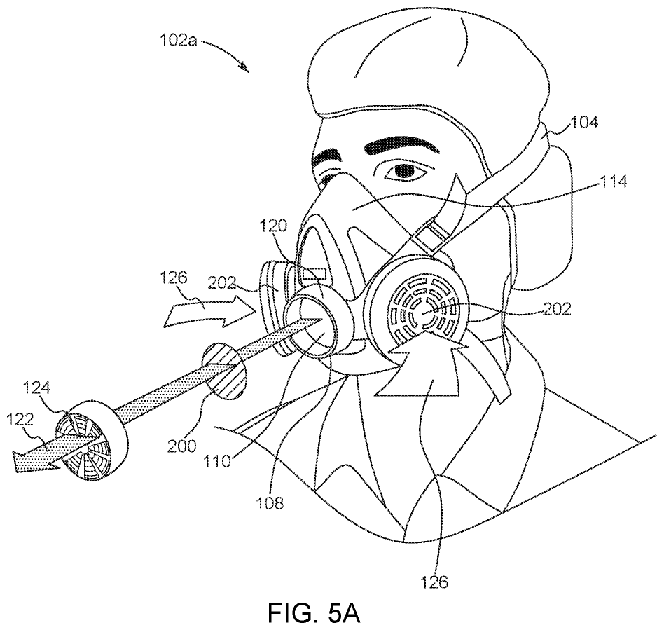

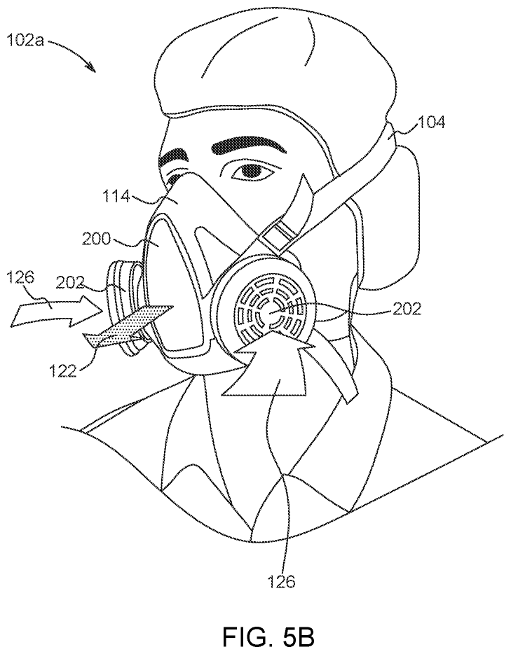

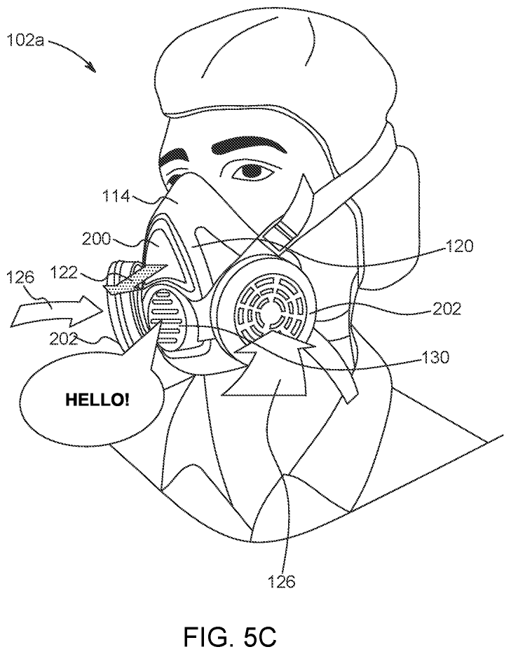

The present invention is directed to a full-face respirator mask 100, a half-face respirator mask 102, and at least one filter 200-700b for use in connection with the full-face respirator mask 100 and/or the half-face respirator mask 102. One non-limiting embodiment or aspect of the full-face respirator mask 100 according to the present disclosure is illustrated in FIGS. 1-2, and another non-limiting embodiment or aspect of the half-face respirator mask 102 according to the present disclosure is illustrated in FIGS. 3-4. In addition, certain non-limiting embodiments of the half-face respirator mask 102 having at least one filter 200-700b are illustrated in FIGS. 5-16. While, as discussed hereinafter, the at least one filter 200-700b can be used in connection with and attached to the full-face respirator mask 100 and the half-face respirator mask 102, the at least one filter 200-700b can be configured or adapted to attach to or fit with any type of respirator mask, respirator, face mask, face piece, and the like.

In some non-limiting embodiments or aspects, and as illustrated in FIGS. 1-2, the full-face respirator mask 100 includes a head harness 104 (shown in FIG. 2), typically including a number of adjustable straps 106, for use in attaching the mask 100 to a head of a user. The head harness 104 is attached to a face piece 114, such that when the adjustable straps 106 are worn, the head harness 104 keeps the face piece 114 sealed against the user's face. Of course, any suitable head harness 104 can be used to releasably and adjustably secure the face piece 114 to the user's face.

With continued reference to FIGS. 1-2, the full-face respirator mask 100 further includes the face piece 114 configured for covering the entire face of the user and forming a seal therewith. The face piece 114 includes a face shield 116, which is a transparent member through which the user can view the surrounding environment (as the full-face respirator mask 100 covers the entirety of the user's face). In some non-limiting embodiments or aspects, the face piece 114 is made from a soft, elastic material whose edge region is configured to follow the contours of the user's face to create a seal against the user's face. For example, the face piece 114 may be made from silicone or a similar elastomeric material.

The face piece 114 further includes at least one air exhalation portion 108 or arrangement configured to facilitate the passage of exhaled air from the user out of an inner area 110 (shown in FIG. 2) between the user's face and an inner sidewall of the face piece 114. In particular, as the user exhales air within the inner area 110 of the full-face respirator mask 100, the exhaled air moves through the air exhalation portion 108. In some non-limiting embodiments or aspects, a single air exhalation portion 108 may be provided on a front portion of the face piece 114. In other non-limiting embodiments or aspects, a pair of air exhalation portions 108 may be provided on lateral sides of the face piece 114. In further non-limiting embodiments or aspects, a plurality of air exhalation portions 108 may be provided on the face piece 114 to facilitate exit of exhaled air from the inner area 110 of the face piece 114. As described herein, the exhaled air exits the face piece 114 through the at least one air exhalation portion 108 via the at least one filter unit 10.

With continued reference to FIGS. 1-2, the face piece 114 includes at least one (and typically two) air inhalation portions 112 or arrangements. These air inhalation portions 112 or arrangements are used to facilitate the passage of filtered air from a filter unit 10 into the inner area 110 of the face piece 114. In some non-limiting embodiments or aspects, the full-face respirator mask 100 may have a pair of air inhalation portions 112 positioned on lateral sides of the face piece 114. In some non-limiting embodiments or aspects, the at least one air exhalation portion 108 and the at least one air inhalation portion 112 may define the same portion of the face piece 114. In such embodiments or aspects, the full-face respirator mask 100 may be configured for two-way filtering of inhaled air and exhaled air, as described herein.

In some non-limiting embodiments or aspects, at least one filter unit 10 is provided for filtering at least one of the inhaled air and the exhaled air. The at least one filter unit 10 is removably attachable to the full-face respirator mask 100, such as to at least a portion of the air exhalation portion 108 and/or the air inhalation portion 112. In some non-limiting embodiments or aspects, the at least one filter unit 10 may be removably attachable to the full-face respirator mask 100 via one or more bayonet connectors 118 that are configured for interacting with corresponding one or more grooves 11 on the at least one filter unit 10. In other non-limiting embodiments or aspects, the at least one filter unit 10 may be removably attachable to the full-face respirator mask 100 using any other connection mechanism, such as via one or more clips, snaps, interference fit, threaded engagement, or other mechanical connection.

In other non-limiting embodiments or aspects, and as illustrated in FIGS. 3-4, the half-face respirator mask 102 includes similar components to those discussed above in connection with the full-face respirator mask 100, including, but not limited to, the head harness 104 (e.g., the straps 106), the air exhalation portion 108, the inner area 110, the air inhalation portions 112, and the face piece 114. Accordingly, these components will not be described in any further detail, aside from any differences therebetween. The face piece 114 of the half-face mask 102 only covers a portion of the user's face, and typically does not include the face shield 116 discussed above. Instead, the user normally wears safety glasses or the like depending upon the environment in which he or she is working. Also, as discussed above in connection with the full-face respirator mask 100, the half-face respirator mask 102 may include any number of air exhalation portions 108 and/or air inhalation portions 112, where a filter unit 10 is used in connection with or fitted to the air inhalation portions 112 of the respirator mask 102. In some non-limiting embodiments or aspects, the full-face respirator mask 100 and/or the half-face respirator mask 102 may be a mask from the ADVANTAGE and/or COMFO product lines of masks manufactured by MSA Safety, Inc. of Cranberry, Pa.

With reference to FIG. 5A, a non-limiting embodiment or aspect of a half-face respirator mask 102a having at least one filter 200 (hereinafter referred to as “filter 200”) will now be discussed in greater detail. While FIG. 5A shows the half-face respirator mask 102a, it is to be understood that the at least one filter 200 may also be used with a full-face respirator mask, such as shown in FIGS. 1-2. The mask 102a may have at least one first filter 202 for filtering ambient air that is drawn into the mask 102 in a direction of arrows 126. In some embodiments or aspects, the at least one first filter 202 may be a conventional cartridge filter that is removably connectable to the face piece 114. In this embodiment or aspect, the at least one first filter 202 may have a valve that is closed during exhalation.

With continued reference to FIG. 5A, the air exhalation portion 108 on the face piece 114 includes an air outlet 120, which is configured or arranged to facilitate the passage of air therethrough in a direction from the inner area 110 of the face piece 114 toward the exterior of the face piece 114, as indicated by arrow 122. The air outlet 120 is configured to receive an air exhalation valve 124. In some embodiments or aspects, the air exhalation valve 124 may be a one-way valve configured to permit passage of exhaled air from the inner area 110 of the face piece 114 in a direction of arrow 122 and restrict passage of air in a direction opposite to arrow 122. The air exhalation valve 124 may be removably connected to the air outlet 120 to allow for replacement of the air exhalation valve 124 separate from the mask 102a. For example, the air exhalation valve 124 may be connected to the air outlet 120 by a threaded engagement, a bayonet connection, one or more clips or connectors, via an adhesive connection, friction interference fit, and any combination thereof.

With continued reference to FIG. 5A, a second filter 200 may be disposed within the air outlet 120 between the inner area 110 of the face piece 114 and the air exhalation valve 124. The second filter 200 desirably covers the entire air outlet portion 120 such that all exhaled air must pass through the filter 200 before passing to the ambient air. The second filter 200 may be removably or non-removably connected to the air exhalation valve 124. In some non-limiting embodiments or aspects, the second filter 200 may be removably or non-removably connected to another portion of the face piece 114 such that the second filter 200 is in fluid communication with the exhalation valve 124. In some non-limiting embodiments or aspects, the second filter 200 may be spaced apart from the air exhalation valve 124. In some non-limiting embodiments or aspects, the second filter 200 may be disposed on an outer portion of the air outlet 120 forward of the air exhalation valve 124. The second filter 200 and/or the air exhalation valve 124 may be replaceable.

The filter 200 may be configured for capturing moisture buildup in the air outlet 120 caused by the exhalation of the user's breath. In some non-limiting embodiments or aspects, the filter 200 may be configured to facilitate a passage of air exhaled by the user wearing the mask 102a in the direction of arrow 122 into the ambient air while reducing a passage of aerosolized particulate matter exhaled by the user. In some embodiments or aspects, the filter 200 may be configured to meet bacterial and viral filtering efficiency requirements for medical use. In some embodiments or aspects, the filter 200 may be configured to a lower level of bacterial and viral filtering efficiency that is suitable for non-medical use but provides advantages in cost, durability, longevity, or breathing effort while still providing some level of filtration, suitable for first responders, law enforcement, food preparation, or other applications.

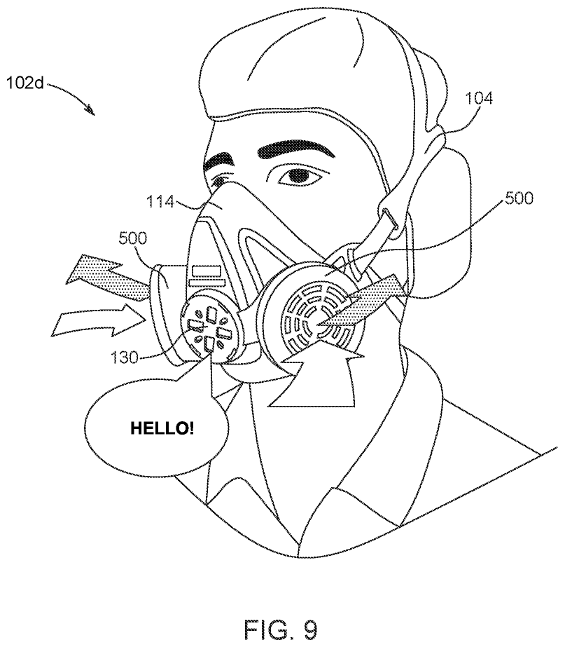

FIG. 5B shows another embodiment or aspect of the mask 102a shown in FIG. 5A, wherein the filter 200 is positioned on an exterior of the face piece 114 and in front of the exhalation valve 124 (shown in FIG. 5A). The remaining features of the mask 102a shown in FIG. 5B are identical to the features of the mask 102a shown in connection with FIG. 5A. Accordingly, a detailed discussion of such features is omitted. In some non-limiting embodiments or aspects, the respirator mask 102a may have a speech diaphragm 130, such as shown in FIG. 5C. The structure and functionality of the speech diaphragm 130 will be described in connection with FIGS. 9-11B.

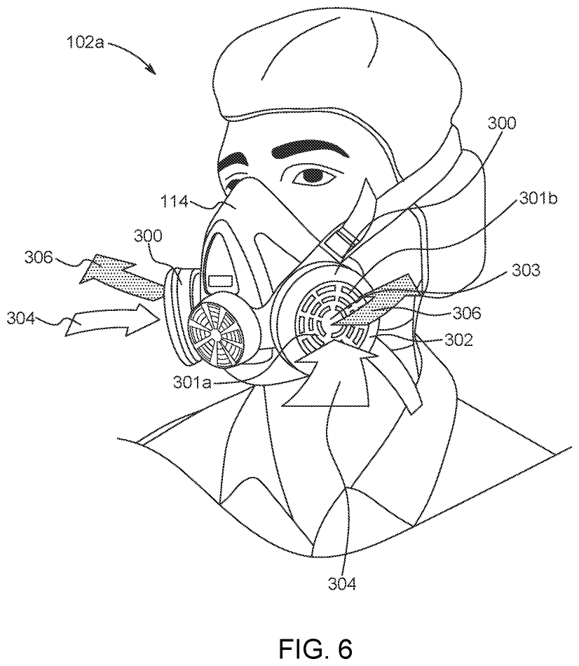

With reference to FIG. 6, a non-limiting embodiment or aspect of the half-face respirator mask 102b having at least one filter 300 (hereinafter referred to as “filter 300”) will now be discussed in greater detail. While FIG. 6 shows the half-face respirator mask 102b, it is to be understood that the filter 300 may also be used with a full-face respirator mask, such as shown in FIGS. 1-2. The filter 300 may be a combined filter configured for filtering ambient air prior to inhalation and filtering exhaled air prior to exhausting the exhaled air into the ambient air.

The filter 300 may include a body 302 having an air inlet portion 301a, which is configured or arranged to facilitate the passage of air therethrough in a direction of arrow 304, and an air outlet portion 301b, which is configured or arranged to facilitate the passage of exhaled air to the ambient air in a direction of arrow 306. In some embodiments or aspects, the air inlet portion 301a and the air outlet portion 301b may be the same feature.

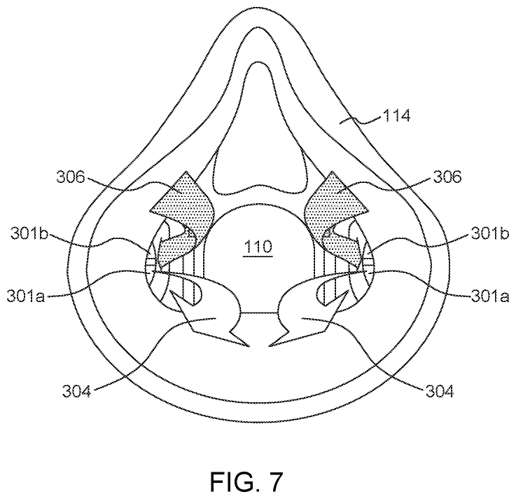

In some non-limiting embodiments or aspects, the air inlet portion 301a and the air outlet portion 301b may have a filter medium 303 positioned in the body 302. In this manner, the exhaled air filtering efficiency is equal to the inhaled air filtering efficiency. Inhaled air and exhaled air may be routed through a common breathing passageway, such as a passageway defined by combined air inlet portion 301a and air outlet portion 301b, on the face piece 114 in the direction of arrows 304 and 306, respectively (shown in FIG. 7). In this embodiment or aspect, the filter 300 would not have a valve that is selectively closable depending on the direction of airflow through the filter.

In some embodiments or aspects, the filter 300 may include a first air passage which is configured or arranged to facilitate the passage of inhaled air therethrough in a direction of arrow 304, and a second air passage different from the first air passage which is configured or arranged to facilitate the passage of exhaled air in a direction of arrow 306, such that inhalation and exhalation pass through the different passages. Each of the passages may have a separate filter medium 303. In some embodiments or aspects, the two passages may share a common filter medium 303.

The body 302 may include a connector, such as one or more grooves 11 (shown in FIGS. 1 and 3) for removably attaching the filter 300 to the mask 102b, such as to the one or more bayonet connectors 118 (shown in FIGS. 1 and 3). In some non-limiting embodiments or aspects, the arrangement of the one or more grooves 11 and the one or more bayonet connectors 118 may be reversed such that the one or more grooves 11 are provided on the face piece 118 of the mask 102b and the one or more bayonet connectors 118 are provided on the filter 300. In some non-limiting embodiments or aspects, the filter 300 may be removably attachable to the mask 102b using any other connection mechanism, such as via one or more clips, snaps, interference fit, threaded engagement, or other mechanical connection.

The filter 300 may be configured for capturing moisture buildup in the mask 102 caused by the exhalation of the user's breath from exiting the mask 102. In some embodiments or aspects, the filter 300 may be configured to facilitate a passage of air exhaled by the user wearing the respirator mask 102 in the direction of arrow 306 into the ambient air while reducing a passage of aerosolized particulate matter exhaled by the user. In some embodiments or aspects, the filter 300 may be configured to meet bacterial and viral filtering efficiency requirements for medical use. In some embodiments or aspects, the filter 300 may be configured to a lower level of bacterial and viral filtering efficiency that is suitable for non-medical use but provides advantages in cost, durability, longevity, or breathing effort while still providing some level of filtration, suitable for first responders, law enforcement, food preparation, or other applications.

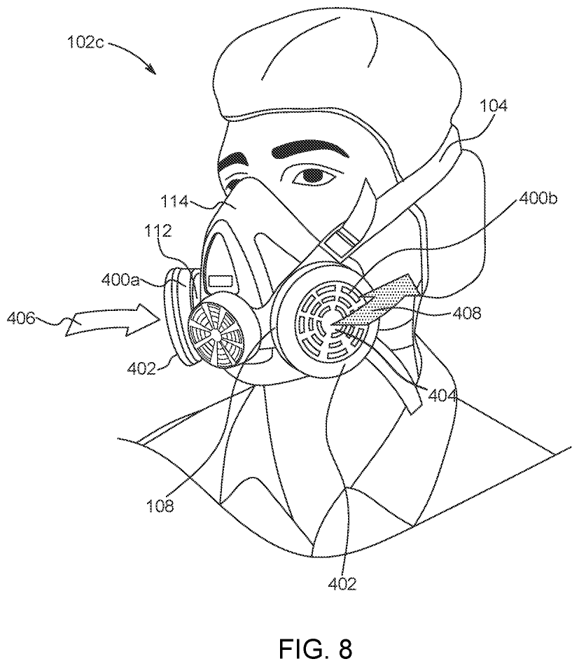

With reference to FIG. 8, a non-limiting embodiment or aspect of the half-face respirator mask 102c having at least one inhalation filter 400a (hereinafter referred to as “inhalation filter 400a”) and at least one exhalation filter 400b (hereinafter referred to as “exhalation filter 400b”) will now be discussed in greater detail. While FIG. 8 shows the half-face respirator mask 102c, it is to be understood that the inhalation filter 400a and the exhalation filter 400b may also be used with a full-face respirator mask, such as shown in FIGS. 1-2.

With continued reference to FIG. 8, the mask 102c includes the face piece 114 having an air inhalation portion 112 on a first lateral side of the face piece 114 and an air exhalation portion 108 on a second lateral side of the face piece 114. The air inhalation portion 112 is configured to facilitate the passage of filtered air from the inhalation filter 400a into the inner area of the face piece 114. The air exhalation portion 108 is configured to facilitate the passage of exhaled air from the inner area of the face piece 114 into the ambient air via the exhalation filter 400b.

The inhalation filter 400a and the exhalation filter 400b each have a body 402 having a connector, such as one or more grooves 11 (shown in FIGS. 1 and 3) for removably attaching the inhalation filter 400a and the exhalation filter 400b to the mask 102c, such as to the one or more bayonet connectors 118 (shown in FIGS. 1 and 3). In some non-limiting embodiments or aspects, the arrangement of the one or more grooves 11 and the one or more bayonet connectors 118 may be reversed such that the one or more grooves 11 are provided on the face piece 118 of the mask 102c and the one or more bayonet connectors 118 are provided on the inhalation filter 400a and the exhalation filter 400b. In some non-limiting embodiments or aspects, the inhalation filter 400a and the exhalation filter 400b may be removably attachable to the mask 102c using any other connection mechanism, such as via one or more clips, snaps, interference fit, threaded engagement, or other mechanical connection.

Each of the inhalation filter 400a and the exhalation filter 400b has a one-way valve 404. For the inhalation filter 400a, the one-way valve 404 is configured to be in an open position during inhalation of air and in a closed position during exhalation of air. Conversely, for the exhalation filter 400b, the one-way valve 404 is configured to be in a closed position during inhalation and in an open position during exhalation of air. In this manner, the inhalation filter 400a is configured to facilitate a passage of filtered air into the inner area 110 of the face piece 114 in the direction of arrow 406 and prevent the passage of exhaled air in a direction opposite to the direction of arrow 406. Conversely, the exhalation filter 400b is configured to facilitate a passage of air exhaled by the user from the inner area 110 of the face piece 114 in the direction of arrow 408 while reducing a passage of aerosolized particulate matter exhaled by the user, and prevent the passage of ambient air into the inner area 110 of the face piece 114 in a direction opposite to the direction of arrow 408.

In some non-limiting embodiments or aspects, at least one of the inhalation filter 400a and the exhalation filter 400b may be configured to meet bacterial and viral filtering efficiency requirements for medical use. In some embodiments or aspects, at least one of the inhalation filter 400a and the exhalation filter 400b may be configured to a lower level of bacterial and viral filtering efficiency that is suitable for non-medical use but provides advantages in cost, durability, longevity, or breathing effort while still providing some level of filtration, suitable for first responders, law enforcement, food preparation, or other applications.

With reference to FIG. 9, a non-limiting embodiment or aspect of the half-face respirator mask 102d having at least one filter 500 (hereinafter referred to as “filter 500”) will now be discussed in greater detail. The respirator mask 102d shown in FIG. 9 is substantially identical to the respirator mask 102b shown in FIG. 6. Similarly, the filter 500 shown in FIG. 9 is substantially identical to the filter 300 shown in FIG. 6. Accordingly, only the relative differences between the embodiments or aspects shown in FIGS. 6 and 9 will be described in detail.

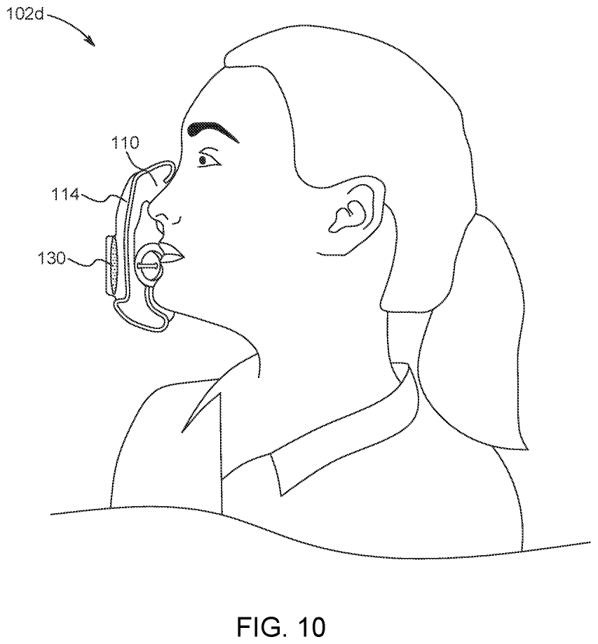

With continued reference to FIG. 9, the respirator mask 102d has a speech diaphragm 130 that is configured to make it easier to hear the user's voice when speaking while wearing the mask 102. The speech diaphragm 130 may be fixed to the front portion of the face piece 114 in an area directly in front of the user's mouth, such as shown in FIG. 10. In some non-limiting embodiments or aspects, the speech diaphragm 130 has a housing 131 and an acoustic membrane 133 that is configured to vibrate during speech. The speech diaphragm 130 is configured to improve the sound quality of the user's voice by reducing or eliminating the attenuation of the sound waves provided by the face piece 114. In some embodiments or aspects, the speech diaphragm 130 provides a sealed connection between the acoustic membrane 133 and the face piece 114, while improving transmission of acoustic pressure waves generated by speech from the inside of the face piece 114 to the outside of the face piece 114.

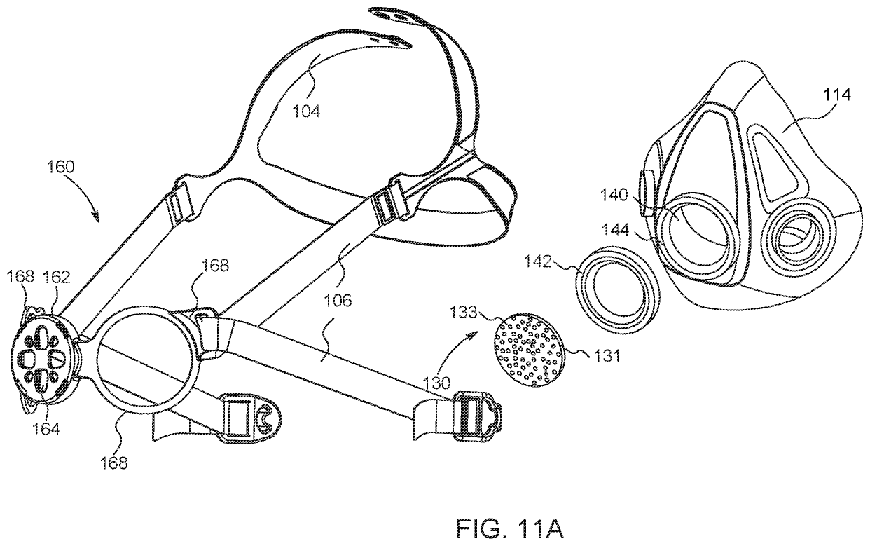

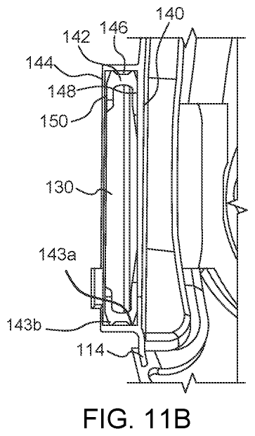

With reference to FIG. 11A, the face piece 114 has an opening 140 configured for receiving the speech diaphragm 130. In some non-limiting embodiments or aspects, the speech diaphragm 130 has a gasket 142 surrounding an outer perimeter of the speech diaphragm 130. The speech diaphragm 130 may have a circular shape and the gasket 142 may have a ring shape that is configured to fit around the perimeter of the circular speech diaphragm 130. The gasket 142 may be made from an elastomeric material and is configured to seal against the opening 140 on face piece 114 when the gasket 142 and the speech diaphragm 130 are inserted into the opening 140. A yoke 160 may have a retainer 162 for preventing the diaphragm 130 from falling out of the face piece 114. The retainer 162 may have one or more openings 164 to permit unmuffled travel of sound waves from the speech diaphragm 130. The yoke 160 has a pair of slots 168 on opposing sides of the retainer 162 configured for connecting to the one or more adjustable straps 106 of the head harness 104 (shown in FIGS. 1-4).

In some non-limiting embodiments or aspects, such as shown in FIG. 11B, the opening 140 may have a shroud 144 configured to receive the gasket 142 within the shroud 144. The shroud 144 may be integrally formed with the face piece 114, or it may be removably attachable to the face piece 114. The shroud 144 may surround the opening 140 and extend away from the opening 140 such that a recess 146 is defined between an outer surface 148 of the face piece 114 and an inner surface 150 of the shroud 144. The gasket 142 is positioned within the recess 146 and may have a first sealing surface 143a that seals against the shroud 144 at a first point of contact and a second sealing surface 143b that seals against the shroud 144 at a second point of contact, as shown in FIG. 11B. The first sealing surface 143a and the second sealing surface 143b are circumferentially continuous around the gasket 142. In this manner, the gasket 142 prevents air from coming into the inner area 110 or out of the inner area 110 of the face piece 114 via the opening 140.

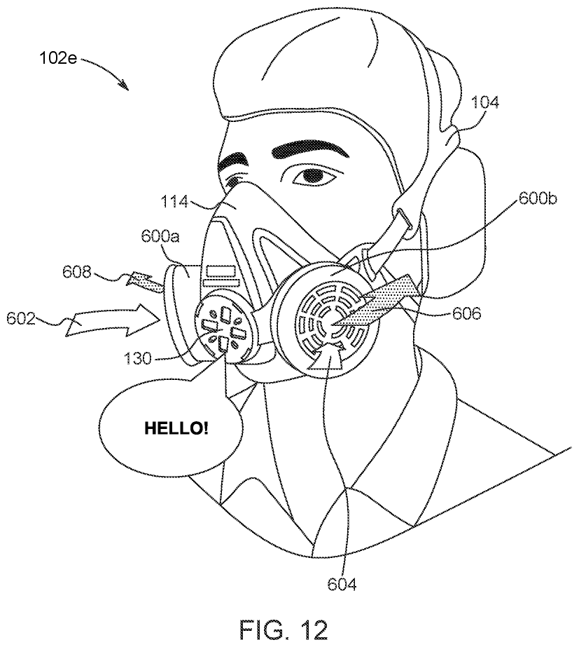

With reference to FIG. 12, a non-limiting embodiment or aspect of the half-face respirator mask 102e having at least one filter 600 (hereinafter referred to as “filter 600”) will now be discussed in greater detail. The respirator mask 102e shown in FIG. 12 is substantially identical to the respirator mask 102d shown in FIG. 9. Similarly, the filter 600 shown in FIG. 12 is substantially identical to the filter 500 shown in FIG. 9. Accordingly, only the relative differences between the embodiments or aspects shown in FIGS. 9 and 12 will be described in detail.

The filter 600 in FIG. 12 comprises a first filter 600a and a second filter 600b. In some non-limiting embodiments or aspects, the first and second filters 600a, 600b may be configured to permit preferential directional breathing. Both the first filter 600a and the second filter 600b may be configured to facilitate the passage of air into the face piece 114 and out of the face piece 114. However, the first filter 600a may be configured to permit more air to flow into the face piece 114 in a direction of arrow 602 than the second filter 600b in the direction of arrow 604. Similarly, the second filter 600b may be configured to permit more air to flow out the face piece 114 in a direction of arrow 606 than the first filter 600a in the direction of arrow 608.

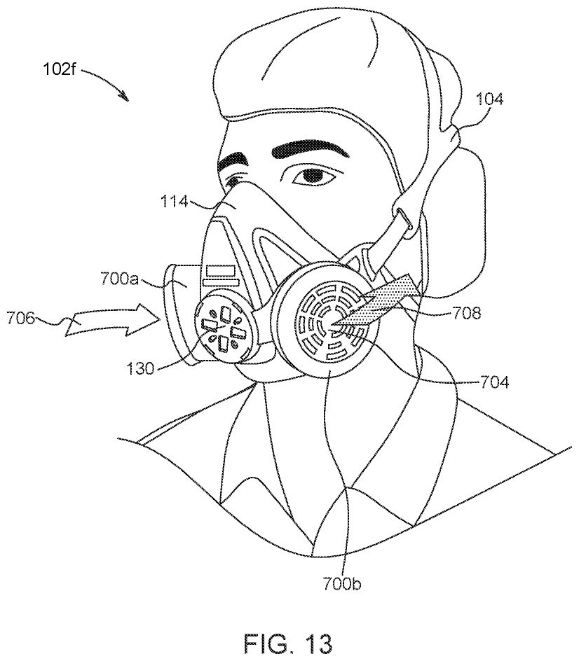

With reference to FIG. 13, a non-limiting embodiment or aspect of the half-face respirator mask 102f having at least one inhalation filter 700a (hereinafter referred to as “inhalation filter 700a”) and at least one exhalation filter 700b (hereinafter referred to as “exhalation filter 700b”) will now be discussed in greater detail. While FIG. 13 shows the half-face respirator mask 102f, it is to be understood that the inhalation filter 700a and the exhalation filter 700b may also be used with a full-face respirator mask, such as shown in FIGS. 1-2. The respirator mask 102f shown in FIG. 13 is substantially identical to the respirator mask 102d shown in FIG. 9, so a detailed discussion of the features of the respirator mask 102f will be omitted.

Each of the inhalation filter 700a and the exhalation filter 700b has a one-way valve 704. For the inhalation filter 700a, the one-way valve 704 is configured to be in an open position during inhalation of air and in a closed position during exhalation of air. Conversely, for the exhalation filter 700b, the one-way valve 704 is configured to be in a closed position during inhalation and in an open position during exhalation of air. In this manner, the inhalation filter 700a is configured to facilitate a passage of filtered air into the inner area 110 of the face piece 114 in the direction of arrow 706 and prevent the passage of exhaled air in a direction opposite to the direction of arrow 706. Conversely, the exhalation filter 700b is configured to facilitate a passage of air exhaled by the user from the inner area 110 of the face piece 114 in the direction of arrow 708 while reducing a passage of aerosolized particulate matter exhaled by the user, and prevent the passage of ambient air into the inner area 110 of the face piece 114 in a direction opposite to the direction of arrow 708.

In some non-limiting embodiments or aspects, at least one of the inhalation filter 700a and the exhalation filter 700b may be configured to meet bacterial and viral filtering efficiency requirements for medical use. In some embodiments or aspects, at least one of the inhalation filter 700a and the exhalation filter 700b may be configured to a lower level of bacterial and viral filtering efficiency that is suitable for non-medical use but provides advantages in cost, durability, longevity, or breathing effort while still providing some level of filtration, suitable for first responders, law enforcement, food preparation, or other applications.

The non-limiting embodiments or aspects of the present disclosure have been described in detail herein. However, it will be appreciated by those skilled in the art that various modifications and alternatives to the embodiments or aspects may be made without departing from the concepts disclosed in the foregoing description. Such modifications are to be considered as included within the following claims unless the claims, by their language, expressly state otherwise. Accordingly, the particular embodiments or aspects described in detail hereinabove are illustrative only and are not limiting as to the scope of the disclosure, which is to be given the full breadth of the appended claims and any and all equivalents thereof.

What is claimed is:

1. A respirator mask, comprising:
a face piece configured for contacting at least a portion of a face of a user;
a head harness configured for attaching the respirator mask to a head of the user;
at least one opening on the face piece; and
at least one filter associated with the opening on the face piece,
wherein the at least one filter is configured to facilitate a passage of ambient air to an interior of the face piece in a first direction, and
wherein the at least one filter is configured to facilitate a passage of air exhaled by the user wearing the respirator mask in a second direction opposite the first direction from the interior of the face piece to the ambient air and reduce a passage of aerosolized particulate matter exhaled by the user in the second direction.

2. The respirator mask of claim 1, wherein the at least one filter is a valveless, two-way filter.

3. The respirator mask of claim 1, wherein the at least one filter comprises a first connector, wherein the opening on the face piece comprises a second connector, and wherein the first connector and the second connector are configured to permit removable attachment of the at least one filter to the face piece.

4. The respirator mask of claim 1, wherein the at least one filter meets bacterial and viral filtering efficiency for medical or non-medical use.

5. The respirator mask of claim 1, further comprising a speech diaphragm connected to a speech opening on the face piece positioned in front of a mouth of the user.

6. The respirator mask of claim 5, wherein the speech diaphragm is an acoustic membrane and wherein an elastomeric gasket surrounds a perimeter of the acoustic membrane.

7. The respirator mask of claim 6, wherein the face piece comprises a recess surrounding the speech opening, and wherein the gasket is received within the recess.

8. The respirator mask of claim 7, wherein the gasket has a first sealing surface configured for making a first point of contact with the recess and a second sealing surface configured for making a second point of contact with the recess.

9. The respirator mask of claim 1, wherein the at least one filter comprises a first filter and a second filter, wherein the first filter is configured for preferential flow in the first direction and secondary flow in the second direction, and wherein the second filter is configured for preferential flow in the second direction and secondary flow in the first direction.

10. A respirator mask, comprising:
a face piece configured for contacting at least a portion of a face of a user;
a head harness configured for attaching the respirator mask to a head of the user;
an air inlet on the face piece, the air inlet having at least one first filter configured to facilitate a passage of ambient air to an interior of the face piece in a first direction;
an air outlet on the face piece, the air outlet having at least one second filter configured to facilitate a passage of air exhaled by the user wearing the respirator mask in a second direction opposite the first direction from the interior of the face piece to the ambient air and reduce a passage of aerosolized particulate matter exhaled by the user in the second direction.

11. The respirator mask of claim 10, wherein one of the air inlet and the at least one first filter comprises a one-way air inhalation valve that is configured to be in an open position during inhalation and in a closed position during exhalation.

12. The respirator mask of claim 10, wherein one of the air outlet and the at least one second filter comprises a one-way air exhalation valve that is configured to be in an open position during exhalation and in a closed position during inhalation.

13. The respirator mask of claim 10, wherein the at least one first filter comprises a first connector, wherein the air inlet on the face piece comprises a second connector, and wherein the first connector and the second connector are configured to permit removable attachment of the at least one first filter to the face piece.

14. The respirator mask of claim 10, wherein the at least one second filter comprises a first connector, wherein the air outlet on the face piece comprises a second connector, and wherein the first connector and the second connector are configured to permit removable attachment of the at least one second filter to the face piece.

15. The respirator mask of claim 10, wherein the at least one first filter and the at least one second filter meet bacterial and viral filtering efficiency for medical or non-medical use.

16. The respirator mask of claim 10, further comprising a speech diaphragm connected to a speech opening on the face piece positioned in front of a mouth of the user.

17. The respirator mask of claim 16, wherein the speech diaphragm is an acoustic membrane and wherein an elastomeric gasket surrounds a perimeter of the acoustic membrane.

18. The respirator mask of claim 17, wherein the face piece comprises a recess surrounding the speech opening, and wherein the gasket is received within the recess.

19. The respirator mask of claim 18, wherein the gasket has a first sealing surface configured for making a first point of contact with the recess and a second sealing surface configured for making a second point of contact with the recess.

20. The respirator mask of claim 10, wherein the at least one filter comprises a first filter and a second filter, wherein the first filter is configured for preferential flow in the first direction and secondary flow in the second direction, and wherein the second filter is configured for preferential flow in the second direction and secondary flow in the first direction.
